(19) United States
(12) Patent Application Publication
(10) Pub. No.: US 2009/0045178 A1
(43) Pub. Date: Feb. 19, 2009

(54) Laser engraver

(76) Inventors: Che-Kang Hsu, Hsi Chih City (TW); Chung-I Tsao, Hsi Chih City (TW)

Correspondence Address: TROXELL LAW OFFICE PLLC, SUITE 1404, 5205 LEESBURG PIKE, FALLS CHURCH, VA, 22041, US

(21) Appl. No.: 11/889,717

(22) Filed: Aug. 15, 2007

(51) Int. Cl. B23K 26/38

(52) U.S. Cl. 219/121.68

(57) ABSTRACT

A laser engraver comprises a glass laser tube and a modulation mechanism. The glass laser tube is used for outputting laser beam utilized by the laser engraver. The modulation mechanism is provided on the optical path of the output laser beam from the glass laser tube for adjusting the frequency of the output laser beam to achieve optimal engraving effect.

### FIELD OF THE INVENTION

The present invention relates to a laser engraver and, more particularly, to a laser engraver with a modulation mechanism provided on an axis of output laser beam, wherein the frequency can be adjusted to achieve optimal engraving effect.

### BACKGROUND OF THE INVENTION

With the development of laser technology, laser-engraving techniques are widely used. Generally, laser types include gas lasers, chemical lasers, metal-vapor lasers, solid-state lasers, and semiconductor lasers.

The principle of laser engraving is to use laser beam as heat source and direct the laser beam on the surface of a material within a very short period of time. Energy released from the laser beam is used as heating energy to melt the surface of the material. The material is thus engraved by moving the laser beam. Recently, Carbon Dioxide lasers are used widely in laser-engraving techniques. Due to the advancement of the laser engraving techniques, Carbon Dioxide lasers can be used to engrave all non-metal materials, even anodized or Cerdec metal by etching or cutting.

A conventional laser engraver includes a glass laser tube used for enclosing a laser source therein. For example, a glass laser tube of a laser engraver using Carbon Dioxide laser is used to encase mixed air including Carbon Dioxide in a glass tube. A resonant cavity is formed within the glass tube by means of electrodes and lens disposed within two ends of the tube to generate laser beam for engraving a material.

In order to engrave the surface of a material in different levels of deepness by using a laser engraver, the frequency of output laser beam is conventionally adjusted by direct-voltage modulation. However, there are several shortcomings when using direct-voltage modulation. First, continuous operation of strike voltage shortens the lifetime of laser and easily damages or even penetrates the glass tube. Second, engraving speed and quality are limited by low modulation frequency. Third, energy power of laser beam changes suddenly when direct-voltage modulation is used and the power of the laser beam is lower compared with constant level, so that the engraving level of deepness is affected.

In order to overcome all disadvantages described above, there is a need to adjust the frequency of output laser beam according to the desired engraving deepness on the surface of a material to achieve optimal engraving effect, the inventor is thus to study and develop the present invention after hard research.

### SUMMARY OF THE INVENTION

An object of the present invention is to provide a laser engraver disposed with a modulation mechanism on an axis of output laser beam for adjusting the frequency of the output laser beam to achieve optimal engraving effect.

In order to achieve the aforementioned object, the present invention provides a laser engraver comprising a glass laser tube and a modulation mechanism, wherein the glass laser tube is used for outputting laser beam utilized by the laser engraver, and the modulation mechanism is provided on an axis of the output laser beam from the glass laser tube and used for adjusting the frequency of the output laser beam.

Other objects, advantages and novel features of this invention will be apparent after reading the following detailed description when taken in conjunction with the accompanying drawings.

### BRIEF DESCRIPTION OF THE DRAWINGS

FIG. 1 is a perspective view of a first embodiment of the present invention;

FIG. 2 is a partially enlarged diagram of FIG. 1;

FIG. 3 is another partially enlarged diagram of FIG. 1.

### DETAILED DESCRIPTION OF THE PREFERRED EMBODIMENT

The present invention provides a laser engraver comprising a glass laser tube 2 and a modulation mechanism 1. The glass laser tube 2 is used for outputting laser beam utilized by the laser engraver. The modulation mechanism 1 is provided on the optical path of the output laser beam from the glass laser tube 2 and used for adjusting the frequency of the output laser beam

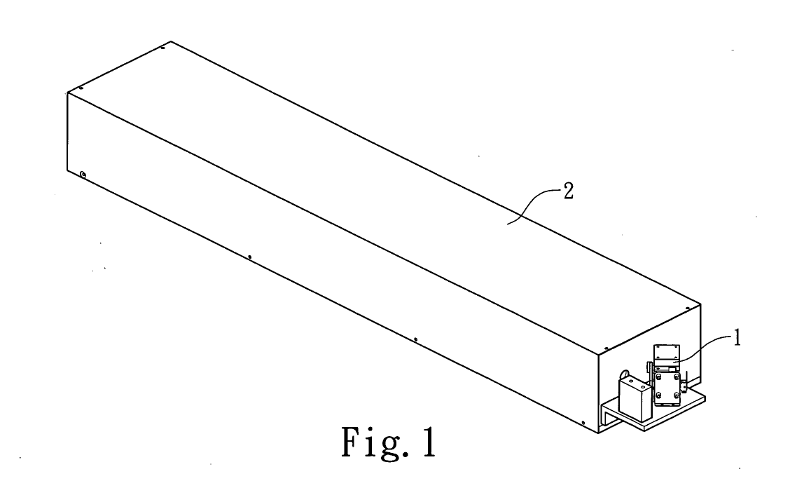

FIG. 1 is a perspective view of the present invention. In this embodiment, the modulation mechanism 1 is connected with one end of the glass laser tube 2 and disposed on the optical path of the output laser beam from the glass laser tube 2.

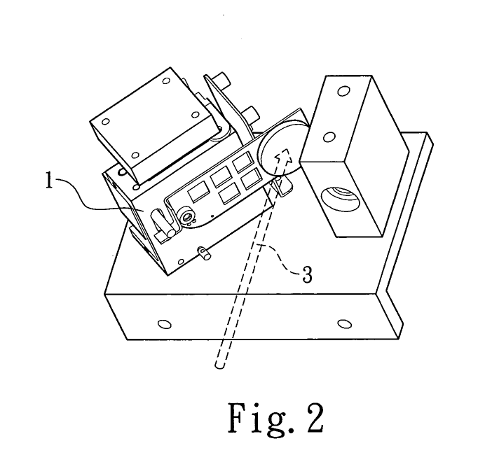

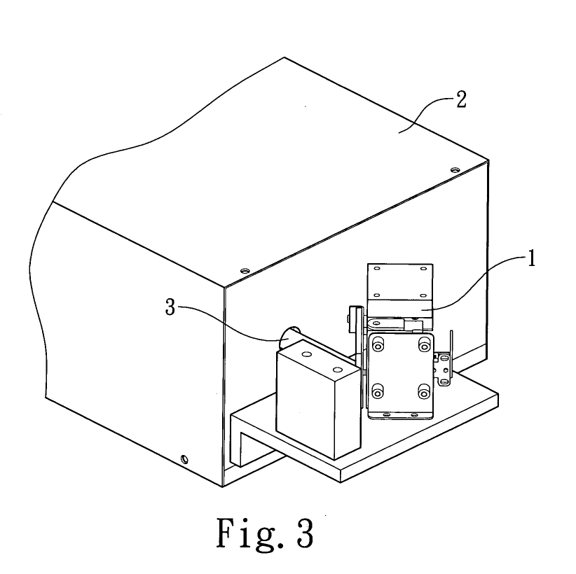

As shown in FIGS. 2-3, in practice, after the glass laser tube 2 is activated, the output laser beam 3 will pass through the modulation mechanism 1 and the frequency of the output laser beam 3 can be adjusted by the modulation mechanism 1. By means of the disposition of the modulation mechanism 1, the glass laser tube 2 can output laser beam continuously to maintain the power of laser beam and achieve optimal engraving effect.

Besides, the modulation mechanism 1 can adopt various modulators to perform its function, such as an electro-optical modulator, an acoustic-optical modulator, or a magnetic-optical modulator.

Thereby, the present invention has following advantages:
1. The present invention can provide a laser engraver with a modulation mechanism for adjusting the frequency of output laser beam to prevent from the shortened lifetime of laser and the damage or even penetration of the glass tube resulted from continuous operation of strike voltage when conventional direct-voltage modulation is used.
2. The present invention can provide a laser engraver with a modulation mechanism for adjusting the frequency of output laser beam to prevent from the limitation of the engraving speed and quality caused by low modulation frequency when conventional direct-voltage modulation is used.
3. The present invention can provide a laser engraver with a modulation mechanism for adjusting the frequency of output laser beam to prevent from the problem that the energy power of laser beam changes suddenly and the power of the laser beam is lower compared with constant level, and consequently the engraving deepness is affected when direct-voltage modulation is used.

Accordingly, the present invention can provide a laser engraver with a modulation mechanism for adjusting the frequency of output laser beam. It is new and can be put into industrial use.

Although the embodiments of the present invention have been described in detail, many modifications and variations may be made by those skilled in the art from the disclosures hereinabove. Therefore, It should be understood that different modifications and variations could be made from the disclosures mentioned above by the people familiar in the art, without departing the spirit of the present invention.

What is claimed is:

1. A laser engraver, comprising:
a glass laser tube for outputting laser beam utilized by the laser engraver; and
a modulation mechanism provided on an axis of the output laser beam from the glass laser tube for adjusting the frequency of the output laser beam.

2. The laser engraver as claimed in claim 1, wherein the modulation mechanism is disposed on the glass laser tube.

3. The laser engraver as claimed in claim 1, wherein the modulation mechanism performs its function of adjusting the frequency of the output laser beam by utilizing an electro-optical modulator, an acoustic-optical modulator, or a magnetic-optical modulator.
